(19) United States
(12) Patent Application Publication
(10) Pub. No.: US 2006/0049154 A1
(43) Pub. Date: Mar. 9, 2006

(54) System and method for bonding camera components after adjustment

(76) Inventors: George M. Clifford JR., Los Altos Hills, CA (US); Richard P. Tella, Sunnyvale, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/936,900

(22) Filed: Sep. 9, 2004

(51) Int. Cl. B23K 26/28

(52) U.S. Cl. 219/121.64; 219/121.63

(57) ABSTRACT

Disclosed are systems and methods which utilize laser plastic welding techniques for bonding camera assembly components after their adjustment to a desired relative position. A plastic material of one camera component to be bonded is adapted to be transparent or translucent to the wavelength of light emitted by a laser, although some portion of visible light is blocked. However, a plastic material of the other camera component to be bonded is adapted to be absorptive of the wavelength of light emitted by the laser.

### CROSS-REFERENCE TO RELATED APPLICATIONS

The present application is related to co-pending and commonly assigned U.S. patent application Ser. No. 10/870,215 entitled “Cam-Locking Positioning Mechanism,” filed Jun. 17, 2004, the disclosure of which is hereby incorporated herein by reference.

### BACKGROUND OF THE INVENTION

Many products contain components that are positioned relative to one another during a manufacturing assembly process. However, after initial positioning, it may be desired that these components be held in a fixed relative position. For example, many cameras (those embedded in wireless telephones for instance) have a fixed focal length. Accordingly, the camera modules, e.g., lens assembly components, may be adjustably focused during manufacturing and then locked for the life of the product.

Current approaches for facilitating adjustment during manufacturing and locking of camera components thereafter include threading a plastic part that holds the lenses (lens holder) into another plastic part that holds the imaging sensor (housing). The spacing between the lens assembly and the sensor is adjusted by turning the threaded engagement. When correctly positioned, UV cure epoxy is typically used to lock the two plastic parts together. A final baking step, such as may involve placing a plurality of parts assemblies into an oven for periods of minutes to hours, may be performed to fully cure the epoxy. The above adjustment and bonding steps are repeated individually for each camera manufactured.

Plastic welding techniques have been used in some industries for bonding plastic parts together in a manufacturing process. For example, laser based plastic welding has been utilized in the automotive industry where liquid and gas-tight joints are desired (e.g., headlight and taillight assemblies).

Plastic laser welding is a non-contact process wherein overlapping joints of separate parts are heated by laser energy and fused together, typically at speeds of from approximately 0.5 meters/minute to approximately 3 meters/minute. Although virtually all thermoplastics can be laser welded, specific material properties with regard to the absorption and transmission of the laser radiation are required for the process to be successfully applied. Specifically, conventional laser welding techniques require an outer overlapping plastic layer to be transparent and the inner overlapping layer to opaque to absorb the laser radiation, thereby allowing the inner overlapping layer to heat to the melting point and bond with the outer overlapping layer when laser energy is applied. Additionally, a good fit between the parts to be joined is typically required to ensure proper bonding and high weld strength.

### BRIEF SUMMARY OF THE INVENTION

The present invention is directed to systems and methods which utilize laser plastic welding techniques in bonding camera assembly components after their adjustment to a desired relative position.

### BRIEF DESCRIPTION OF THE DRAWING

For a more complete understanding of the present invention, reference is now made to the following descriptions taken in conjunction with the accompanying drawing, in which:

FIG. 1 shows components of a camera assembly adapted according to an embodiment in accordance with the invention;

FIG. 2 shows an alternative configuration of components of a camera assembly adapted according to an embodiment in accordance with the invention;

FIG. 3 shows another alternative configuration of components of a camera assembly adapted according to an embodiment in accordance with the invention;

FIG. 4 shows yet another alternative configuration of components of a camera assembly adapted according to an embodiment in accordance with the invention;

FIG. 5 shows a system providing laser plastic welding of camera assembly components according to an embodiment in accordance with the invention; and

FIG. 6 shows a flow diagram of operation providing laser plastic welding of camera assembly components according to an embodiment in accordance with the invention.

### DETAILED DESCRIPTION OF THE INVENTION

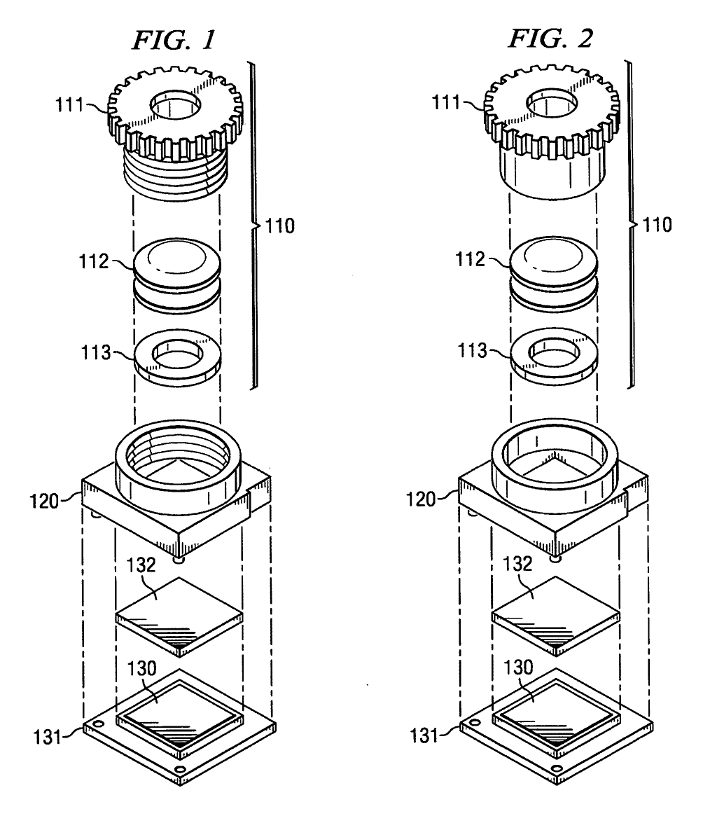

Directing attention to FIG. 1, components of a camera assembly adapted according to an embodiment in accordance with the invention are shown. Specifically, lens holder assembly 110, housing 120, and sensor 130, as may be used in providing a fixed focus camera assembly are shown. Lens holder assembly 110 of the illustrated embodiment includes lens holder 111, lenses and aperture 112, and lens retainer 113, and thus provides optics for focusing an image on sensor 130, perhaps through a filter or other optics such as IR filter 132. Housing 120 may be coupled to, or a part of, a camera body (not shown) fixedly attached to sensor 130, perhaps through other structure such as printed circuit board (PCB) substrate 131, thereby having a fixed position with respect to sensor 130. Accordingly, lens holder assembly 110 may be interfaced with housing 120 and their relative position adjusted such that lenses and aperture 112 properly focus light upon sensor 130.

The embodiment of lens holder 111 and housing 120 illustrated in FIG. 1 provides a threaded interface between lens holder assembly 110 and housing 120. Accordingly, the relative position of lens holder assembly 110 and housing 120, and thus the spacing between lenses and aperture 112 and sensor 130, is adjusted by rotating lens holder 111 in the threaded engagement. The thread configurations used according to embodiments in accordance with the invention are adapted to provide a good fit (e.g., a suitable area of close surface contact) to facilitate a strong laser plastic weld bond. For example, the threads may be configured to have triangular cross-sections sized and spaced to tightly mesh with opposing threads.

Embodiments in accordance with the invention implement different configurations for the interface between lens holder assembly 110 and housing 120. For example, the embodiment of FIG. 2 provides a smooth surface interface between lens holder assembly 110 and housing 120. Accordingly, adjustment of the relative position of lens holder assembly 110 and housing 120 may be made through sliding engagement of these smooth surfaces. The smooth surface configurations used according to embodiments in accordance with the invention are adapted to provide a good fit (e.g., a suitable area of close surface contact) to facilitate a strong laser plastic weld bond. For example, a portion of lens holder 111 which is inserted into a portion of housing 120 may be configured to be slightly oversized (e.g., a portion of lens holder 111 may have an outer diameter from approximately 0.5 mil to 2 mils larger than an inner diameter of an overlapping portion of housing 120) to tightly interface with opposing surfaces.

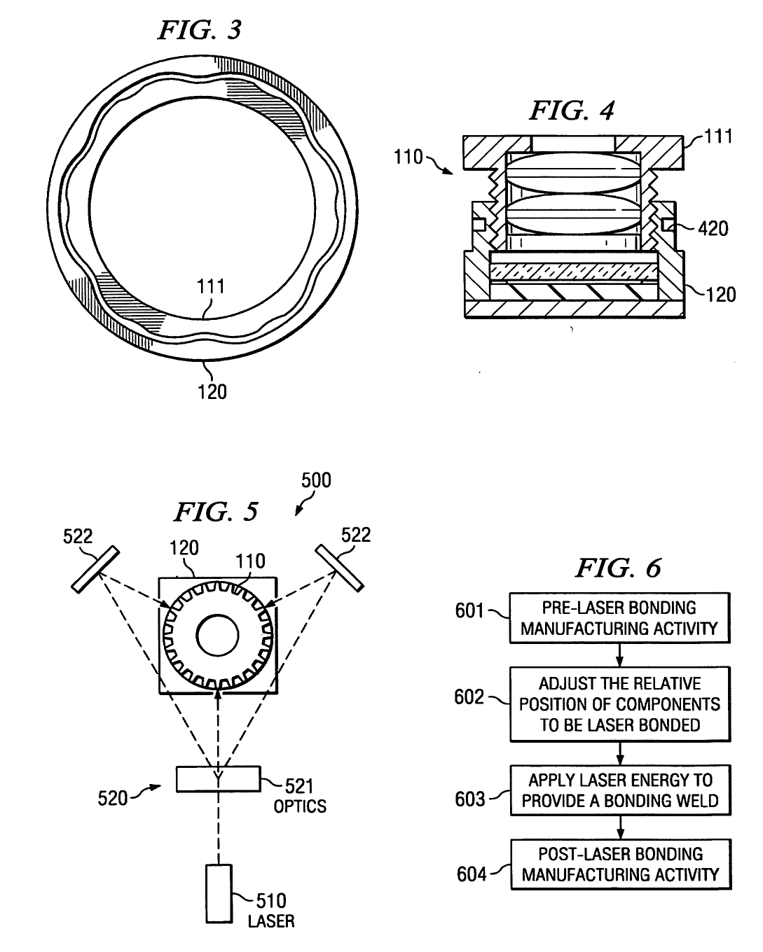

Embodiments in accordance with the invention provide an interface between lens holder assembly 110 which itself may provide a locking engagement between lens holder assembly 110 and housing 120. For example, the embodiment of FIG. 3 provides a cam locking arrangement, as shown and described in further detail in the above referenced patent application entitled “Cam-Locking Positioning Mechanism.” The interface between such cam surfaces provide a good fit (e.g., a suitable area of close surface contact) to facilitate a strong laser plastic weld bond at least at those positions.

Embodiments in accordance with the invention, once a desired relative position of lenses and aperture 112 and sensor 130 is obtained through adjusting the relative positions of lens holder assembly 110 and housing 120, laser energy is applied to bond at least a portion of lens holder 111 to housing 120 through a weld formed when the materials thereof heat to their melting point. For example, a beam from a laser which radiates in the infra-red spectrum may be focused on a portion of housing 120 which overlaps a portion of lens holder 111 to provide a weld.

In order to provide a bond of suitable strength to reliably maintain the desired relative position, embodiments in accordance with the invention employ compatible materials (e.g., materials, such as the same or very similar polymers, which can flow together and adhere to each other when at or above the melting point) between lens holder 111 and housing 120, or at least with respect to the overlapping portions thereof where a weld is to be formed. According to one embodiment, lens holder 111 and housing 120 are both comprised of polycarbonate. However, embodiments in accordance with the invention may use other materials (e.g., thermoplastics such as acrylic, polystyrene, polyamide, acrylonitrile-butadiene-styrene (ABS), and the like) having a melting point achievable through the application of laser energy for relatively short periods of time (e.g., 1-4 seconds), provided the materials of lens holder 111 and housing 120 are compatible with respect to providing a suitable weld bond.

Lens holder 111 and housing 120 of embodiments in accordance with the invention are further adapted to facilitate application of a laser plastic welding process. According to one embodiment, the material of housing 120 is adapted to be transparent or translucent to the wavelength of light emitted by a laser used in the laser plastic welding process, whereas the material of lens holder 111 is adapted to be absorptive of the wavelength of light emitted by a laser used in the laser plastic welding process. Accordingly, laser energy may be passed through housing 120 and absorbed by lens holder 111, thereby causing a portion of lens holder 111 to heat to its melting point (this process often being referred to as “transmission welding”). A portion of housing 120 adjacent to that portion of lens holder 111 heated to its melting point may also be heated to its melting point. For example, a portion of housing 120 may be heated to its melting point through heat conducted/reflected from lens holder 111. Additionally or alternatively, a portion of housing 120 may be heated to its melting point through heat absorbed by housing 120 not being perfectly transparent with respect to the laser energy.

Although comprising a material which is transparent or translucent to the wavelength of light emitted by a laser used in the laser plastic welding process, embodiments of housing 120 are opaque to visible light. Specifically, because housing 120 comprises a camera assembly housing in association with a light path used in imaging, it is desirable to control the infiltration of this path by ambient light during its operation as a camera. Accordingly, the material of housing 120 of embodiments blocks wavelengths of visible light, although passing (or more readily passing) wavelengths of the laser output. For example, a pigment, such as a red pigment, may be added to a polycarbonate base material to provide acceptable transmission qualities with respect to infra-red laser emissions while blocking visible light (or some portion thereof) sufficiently to facilitate camera operation. The use of such a pigment to block some portion of visible light may be particularly useful in some configurations, such as where a black-and-white image is being captured and/or where a colored filter, corresponding to the pigment used, is implemented with respect to the sensor.

Laser energy transmissive and laser energy absorptive properties may be provided in a number of ways, including chemically and structurally. For example, a base polymer, such as polycarbonate, utilized with respect to each of lens holder 111 and housing 120 may be acceptably IR translucent/transparent. Accordingly, lens holder 111 may be chemically adapted to exhibit desired absorptive properties through introduction of an additive, such as carbon black, to the base polymer.

According to another embodiment, housing 120, although perhaps not being acceptably IR translucent, is structurally adapted to allow laser energy to be applied very near an interface between housing 120 and lens holder 111. For example, in the embodiment of FIG. 4 an area of reduced thickness, shown here as welding well 420, is provided in housing 120 at portions of the overlapping region wherein laser welding is to be applied to bond the components. For example, where a laser beam of approximately 2 Watts (e.g., a 0.5 mm beam spot diameter held for 2 seconds in a stationary location) illuminates a point to be welded within welding well 420 of one embodiment, a thickness of the wall at the bottom of welding well 420 may be 0.5 mm to facilitate a suitable bond. For continuous welds, where either the part or the laser beam(s) are moved, additional laser power may be utilized depending upon the velocity of the relative movement. Laser energy may be conducted, or otherwise passed through, the thin walled portion of housing 120 associated with welding well 420 sufficiently to be absorbed by an adjacent portion of lens holder 111. The foregoing welding well may be disposed in juxtaposition with particular structure of the components to be bonded, if desired. For example, welding well 420 may be disposed in juxtaposition with a cam surface of FIG. 3 to facilitate bonding between the lens holder and housing in accordance with the invention.

Laser energy used in providing bonding welds according to embodiments in accordance with the invention may be applied to one or more points or positions as determined to provide a bond of suitable strength. For example, where laser plastic welding techniques of the present invention are used to provide a bond for holding the relative position of components to facilitate employing a different bonding technique, such as heat-cured or time-cured epoxy, a single or a few bonding welds may be used. Moreover, these welds may be relatively small, e.g., the laser energy applied in a very short burst (such as on the order of 0.5-2 seconds), depending upon the laser power and beam spot diameter, to melt and thus weld only a very small area, because a primary bond may be provided by a different bonding technique. However, where laser plastic welding techniques of the present invention are used to provide a sole source bond for holding the relative position of components, a larger number of bonding welds may be used. For example, one embodiment in accordance with the invention uses at least 3 bonding welds, such as may be substantially equally spaced about the overlapping interface of the components, in order to reliably fix the relative position of the components.

Bonding welds according to embodiments in accordance with the invention may be point welds (e.g., “tack” welds) or running welds (e.g., “seam” welds). For example, one or more of the aforementioned at least 3 bonding welds may comprise a point weld resulting from application of laser energy to corresponding points for a period of time, such as on the order of 0.5-4 seconds. Additionally or alternatively, one or more of the aforementioned at least 3 bonding welds may comprise a running weld resulting from relative movement between the assembly and the laser beam during application of laser energy, such as may result in welding speeds of from approximately 0.5 mm/second to approximately 5 mm/second. Although running welds may involve more time to accomplish than point welds, running welds may be desirable in some situations, such as where a seal against gas, liquid or light infiltration is to be provided by the bonding weld.

Directing attention to FIG. 5, system 500 providing laser plastic welding of camera assembly components according to an embodiment in accordance with the invention is shown. In the illustrated embodiment, laser 510 provides laser energy to multiple positions on housing 120 after a desired relative position between lens holder assembly 110 and housing 120 has been achieved in a manufacturing process. Specifically, laser 510, such as may comprise one or more infra-red diode lasers (e.g., emitting energy having approximately 1.1 micron wavelength) delivering power in the range of approximately 1 Watt to approximately 20 Watts (e.g., 3 Watts), outputs a beam which interacts with optics assembly 520, comprised of optical elements 521 and 522, to direct the beam to selected positions on housing 120.

Optical element 521 may comprise a beam splitter operable to substantially equally split the energy of the laser output beam into multiple beams. Such laser beams are directed to illuminate selected portions of housing 120 and provide a welding bond using optical elements 522, such as may comprise mirror surfaces. Specifically, a first beam may be directed to a surface of housing 120 by optical element 521, a second beam may be directed to a surface of housing 120 by a first optical element 522, and a third beam may be directed to a surface of housing 120 by a second optical element. Accordingly, system 500 may be operated to activate laser 510 to emit a single pulse of sufficient duration, e.g., 1-4 seconds, and provide multiple laser plastic welds to bond lens holder 111 to housing 120.

Although the use of a beam splitter and mirror surfaces has been discussed above, embodiments in accordance with the present invention may utilized any number of configurations for delivering laser energy to components to be bonded. For example, laser 510 may illuminate one or more portions of housing 120 without the use of a beam splitter. According to one embodiment, optical element 521 comprises a scanner, e.g., a rotating or moving mirror surface of suitable shape, to direct the output of laser 510 toward one or more positions on housing 120. Such a scanner may be useful in providing running welds, as described above, in addition to or in the alternative to point welds, also as described above. Of course, in addition to or in the alternative to providing optics to direct the output of laser 510, embodiments of the invention may utilize relative movement with respect to laser 510 and a camera component assembly to provide illumination of portions of housing 120. Embodiments in accordance with the invention may provide such illumination without the use of optics assembly 520, if desired. Moreover, embodiments in accordance with the present invention may use multiple lasers to provide laser energy for bonding welds as described herein.

Directing attention to FIG. 6, a flow diagram of operation according to an embodiment in accordance with the present invention is shown. At block 601 pre-laser bonding manufacturing activity is conducted. For example, lens holder 111, lenses and aperture 112, and lens retainer 113 may be assembled into lens holder assembly 110. Thereafter, lens holder assembly 110 may be interfaced with housing 120. Where bonding techniques in addition to laser plastic welding are used in bonding the camera components, additional bonding activity may be performed at block 601. For example, an epoxy resin, such as a heat cure, time cure, or UV cure epoxy resin, may be applied to one or more of lens holder 111 and housing 120 before lens holder assembly 110 is interfaced (or fully interfaced) with housing 120 to be cured at a later time.

At block 602 the relative position of camera components is adjusted. For example, lens holder assembly 111 may be moved with respect to housing 120 to provide a desired focal length between lenses 112 and sensor 130.

At block 603 laser energy is applied to provide a bonding weld between camera components. For example, laser 510 may be energized to emit an IR beam focused on one or more points on housing 120. This energy may pass through housing 120 sufficiently to reach corresponding points on lens holder 111, where the energy is absorbed. This energy may be absorbed sufficiently and applied a sufficient amount of time to cause the points on lens holder 111 to reach the melting point of the material. Additionally, sufficient energy may be absorbed by, or conducted to, points on housing 120 interfacing with the aforementioned points on lens holder 111, thereby allowing the material of each component to flow, intermingle, and provide a weld.

At block 604 post-laser bonding manufacturing activity is performed. For example, additional components of the camera may be assembled, the camera may be tested, etcetera. Where bonding techniques in addition to laser plastic welding are used in bonding the camera components, additional bonding activity may be performed at block 604. For example, curing activity with respect to an epoxy resin, such as to apply heat cure, allow time to pass, or apply UV energy, may be performed (or the addition of an adhesive).

From the above it can readily be seen that laser plastic welding according to embodiments in accordance with the present invention provides a bond which may be applied very quickly and which provides sufficient holding of a desired relative position of components to facilitate further manufacturing processing immediately thereafter. Accordingly, significant time (e.g., several to many seconds) may be saved in the manufacturing of camera assemblies by employing the concepts of the present invention. In a high-volume manufacturing environment, such time savings can have a large impact on the manufacturing cost. Moreover, the use of laser plastic welding according to embodiments in accordance with the present invention may be relied upon to avoid contamination of lenses or sensor surfaces of camera assembly when bonding camera components together. Such camera assemblies may comprise any number of different camera types, including low cost digital cameras such as are now common in cellular telephones, high quality digital cameras, film cameras, and even video cameras.

Although embodiments in accordance with the invention have been described with reference to cameras and camera components, the concepts of the present invention are applicable to a number of different assemblies benefiting from precise adjustment before bonding. Embodiments in accordance with the invention are particularly useful with respect to assemblies wherein opacity with respect to visible light is desired with respect to the bonded components.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for bonding camera components after adjustment, said method comprising:
interfacing a first camera component and a second camera component to provide an overlapping region of contact between said first camera component and said second camera component; and
applying laser energy to at least one portion of said overlapping region.

2. The method of claim 1, wherein said interfacing comprises:
locking cam surfaces between said first camera component and said second camera component.

3. The method of claim 2, wherein said at least one portion of said overlapping region corresponds to a cam surface interface between said first camera component and said second camera component.

4. The method of claim 1, wherein said applying laser energy comprises:
applying laser energy to a plurality of portions of said overlapping region.

5. The method of claim 4, wherein said applying laser energy comprises:
using optical elements to direct a single laser beam to said plurality of portions.

6. The method of claim 1, further comprising:
adapting one of said first camera component and said second camera component to pass said laser energy at said at least one portion of said overlapping region.

7. The method of claim 6, further comprising:
adapting said one of said first camera component and said second component to block all visible light energy.

8. The method of claim 6, further comprising:
adapting the other one of said first camera component and said second camera component to absorb said laser energy at said at least one portion of said overlapping region.

9. The method of claim 1, further comprising:
providing a welding well at said at least one portion of said overlapping region, said welding well providing a thin wall at an interface between said first camera component and said second camera component.

10. The method of claim 1, further comprising:
applying a bonding mechanism in addition to a weld resulting from said laser energy.

11. A system for bonding camera components after adjustment, said system comprising:
a first interface surface of a first camera component;
a second interface surface of a second camera component, wherein said first interface surface and said second interface surface are adapted to provide an overlapping region of contact between said first interface surface and said second interface surface when said first camera component and said second camera component are interfaced; and
a laser energy delivery system delivering laser energy to at least one portion of said overlapping region.

12. The system of claim 11, wherein said first interface surface and said second interface surface comprise corresponding threaded surfaces.

13. The system of claim 11, wherein said first interface surface and said second interface surface comprise smooth surfaces.

14. The system of claim 11, wherein said first interface surface and said second interface surface comprise corresponding cam surfaces.

15. The system of claim 11, wherein said first camera component comprises one of a lens holder and a housing and said second camera component comprises the other one of said lens holder and said housing.

16. The system of claim 11, wherein said first camera component and said second camera component are opaque with respect to visible light.

17. The system of claim 16, wherein one of said first camera component and said second camera component is at least translucent with respect to said laser energy.

18. The system of claim 11, further comprising:
a welding well disposed in a surface of said first camera component opposite said first interface surface, said welding well presenting a thin walled portion of said first camera component at said at least one portion of said overlapping region.

19. The system of claim 11, wherein said first camera component and said second camera component are comprised of polycarbonate.

20. The system of claim 11, wherein said laser energy delivery system comprises:
a laser; and
an optical system to direct a laser beam emitted by said laser at a plurality of portions of said overlapping region.

21. The system of claim 20, wherein said laser comprises an infra-red laser.

22. The system of claim 20, wherein said optical system comprises a beam splitter.

23. The system of claim 20, wherein said optical system comprises a laser beam scanner.

24. The system of claim 11, wherein said laser energy delivery system comprises:
a plurality of lasers.

25. A method for laser welding optical system components, said method comprising:
selecting a material of a first component to be opaque with respect to visible light, said selected material of said first component also being at least translucent with respect to laser light used in said laser welding;
selecting a material of a second component to be compatible for welded bonding with said material of said first component, said selected material of said second component also being absorptive with respect to laser light used in said laser welding;
interfacing said first component and said second component to provide an overlapping region; and
shining said laser light through said material of said first component onto said material of said second component to weld said first component to said second component at said overlapping region.

26. The method of claim 25, wherein said material of said first component and said material of said second component are comprised of a same base polymer.

27. The method of claim 26, wherein said material of said second component comprises an opacifying agent.

28. The method of claim 27, wherein said opacifying agent comprises carbon added to said base polymer in sufficient quantity to be absorptive with respect to said laser light.
